(19) United States
(12) Patent Application Publication
(10) Pub. No.: US 2005/0258958 A1
(43) Pub. Date: Nov. 24, 2005

(54) Personal emergency locator transmitter (ELT) apparatus

(76) Inventor: Joseph Lai, San Pedro, CA (US)

Correspondence Address: JOSEPH LAI, 950 SAMPSON WAY #108, SAN PEDRO, CA, 90731, US

(21) Appl. No.: 10/848,227

(22) Filed: May 18, 2004

(51) Int. Cl. G08B 1/08

(52) U.S. Cl. 340/539.15; 340/573.1

(57) ABSTRACT

A disguised Emergency Locator Transmitter (ELT) device for kids, works as LoJack™ for cars, is installed inside kids' belongings, such as clothes, small toys, dolls, and handheld electronic LCD video games (or as LCD video game cartridges) with built-in GPS receiver and cellular phone for locating kids in case of emergency. Preprogrammed phone numbers such as 911 or parents' phone numbers are dialed with location information when the ELT is powered and activated by recognizing the keystrokes, voice commands or remotely via the cellular phone or paging networks. The kid and the ELT devices will be located by GPS and/or triangulation of the cellular phone or paging base-station towers.

### FIELD OF THE INVENTION

The present invention is related to a device for locating person (mostly kids) in case of emergencies such as lost, missing, kidnapped, abducted and/or all crimes.

### BACKGROUND OF THE INVENTION

The Problem

Over 2000 kids are reported missing everyday. That is the worst thing any parents can experience. Crimes against kids are big problem all over the world. Although modern cellular phones are popular, for kids, it is expensive to own, difficult to use and not effective in case of emergency. (The perpetrator could easily spot the kid's phone and turn it off or simply destroy it.) There are products such as GPS personal locator watch (http://www.gpschildlocatorwatch.com/) for kids, again, these devices are very easily spotted and destroyed by perpetrators and won't be useful in case of real situations. Not just for kids, on the other hand, of course, adults could also get themselves into troubles too.

The Solution

The present invention will directly provide a solution with an electronic Emergency Locator Transmitter (ELT) device which is disguised as kid's toys such as a popular handheld game cartridge or built inside the popular handheld game itself, activated by insert the cartridge into the game, automatically dial 911 or other pre-programmed phone numbers by recognizing the preprogrammed keystrokes, “keywords” or voice command. This process will summon helps from parents or the law-enforcement agencies. In case, the person is not capable of activating the ELT device, the parents or law-enforcement agencies could activate the ELT device remotely via the cellular phone networks to locate the troubled person.

### SUMMARY OF THE INVENTION

Handheld LCD video games; such as Gameboy™ are very popular toys for kids. (Over 21 million have been sold in US) The present invention contains a cellular phone radio, GPS and/or voice recognition device inside the “Gameboy” to locate the person in case of emergency. This device is either retrofitted inside the handheld game or camouflaged as a game cartridge. In case of emergency, the person simply plugs the ELT cartridge into the handheld game, turn it on, talk to the handheld game with preprogrammed “emergency keywords” or press the buttons at certain sequence. The device than recognize a self programmed keyword and dial the emergency 911 to notify parents or police for help. The parents or police than monitoring the GPS information (if available) and/or triangulate the cellular signal based on the cellular tower location to locate the person.

### BRIEF DESCRIPTION OF THE DRAWINGS

FIG. 1 Shows the circuit block diagram of the emergency locator transmitter (ELT) device and the game device

FIG. 2 Shows the Emergency Locator Transmitter (ELT) is assembled inside the game cartridge and about to plug into the game device.

FIG. 3 Shows the method of triangulation for locating the Emergency Locator Transmitter (ELT) device by using the GPS satellites.

FIG. 4 Shows the method of triangulation for locating the Emergency Locator Transmitter (ELT) device by using the cellular base-station sites.

### REFERENCE NUMERALS IN DRAWINGS

101 Handheld LCD Video Game device
102 Circuit for controlling and activating the GPS and the Cellular radio Transceiver
103 Game device logic interface circuit
104 Power supply circuitry for ELT cartridge
105 GPS receiver
106 Encoder, encode GPS longitude/latitude information to cellular radio transceiver
107 Cellular Radio Transceiver
108 Antenna for GPS receiver
109 Antenna for Cellular Radio Transceiver
110 Microphone device for voice recognition and monitoring the surrounding sound of the game device
201 ELT device disguised inside the game cartridge
301 GPS satellite #1
302 GPS satellite #2
303 GPS satellite #3
401 Cellular base-station #1
402 Cellular base-station #2
403 Cellular base-station #3

### DETAILED DESCRIPTION

The present invention consists of cellular/radio phone, GPS and/or voice recognition components working as an Emergency Locator Transmitter (ELT) for kids/persons in case of emergency. This device is either packaged inside the popular handheld LCD video game or as a handheld LCD Video game cartridge that insert into the handheld game.

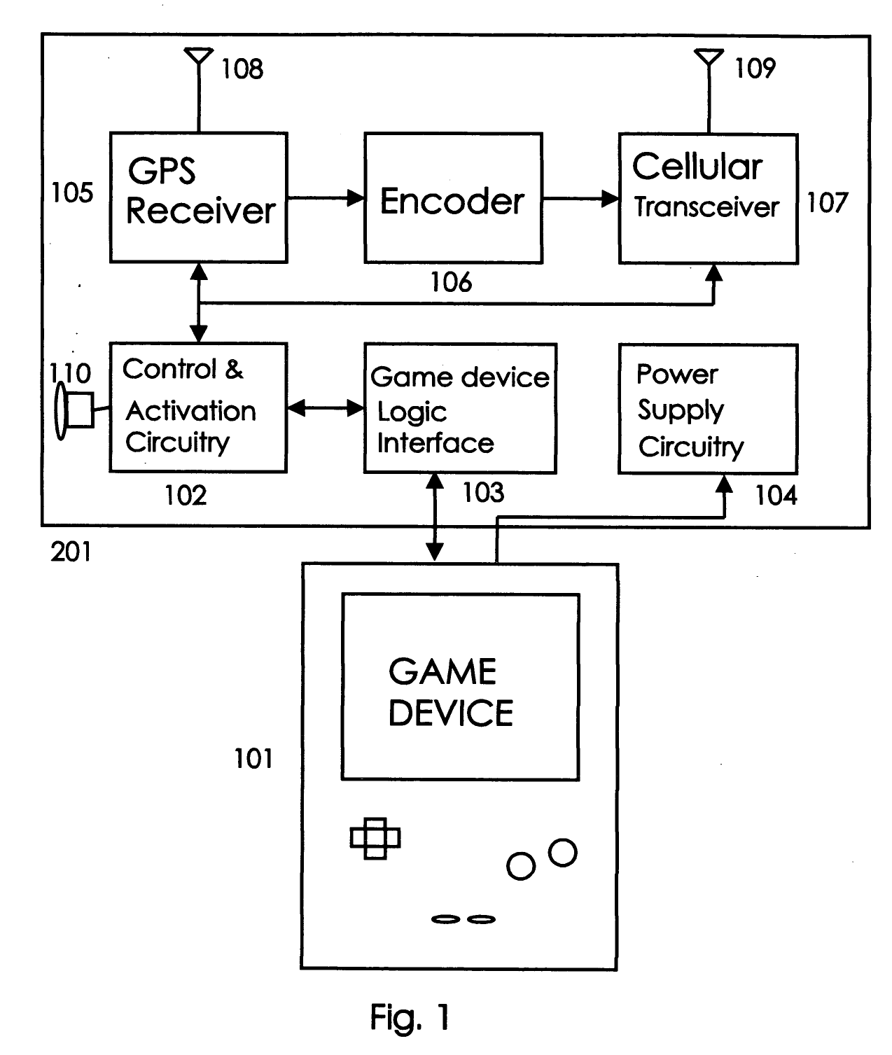

A. The Emergency Locator Transmitter device FIG. 1 of 4 (201) comprising of:
1. GPS receiver module (105) is receiving its position coordinate information from its GPS antenna (108) via 24 satellites in space orbit.
2. The Encoder (106) is capable of encoding and translating the position coordinate information into signals such as:
   i. Digital modulation, send out data bits for the cellular transceiver,
   ii. Analog modulation, such as audio, synthesized voice form, or
   iii. Morse code form of tone signals, for the cellular transceiver (107) to send out to the receiving end.
3. The cellular transceiver module (107) contains cellular phone equivalent circuitry that receives and transmits to the cellular base-stations to communicate voice or data. Cellular transceiver uses antenna (109) for receiving and transmitting information between cellular transceiver and the base-station.
4. Control & Activation circuitry (102) is activated whenever there is a situation when the owner of this ELT device needs assistance. Typically, GPS (105) and cellular transceiver (107) are activated:
   i. By key stroke sequence to the game device,
   ii. Recognition of the voice from microphone (110), or
   iii. Remotely, via the cellular phone network through cellular transceiver (107) module.
5. Game device logic interface (103) circuitry that provides signal buffers, amplifiers and the edge-card connector that physically plugs into the game device (101)
6. Power supply circuitry (104) contains circuitries that:
   i. Regulating the voltages and currents supply to the ELT (201)
   ii. Battery backup incase of battery low.

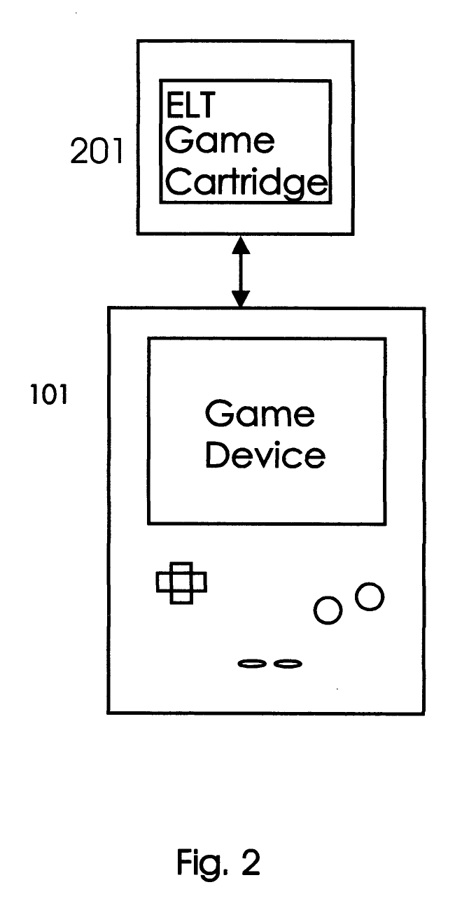

B. Activating in case of emergency FIG. 2 of 4
1. In case of emergency, for the ELT game device users with built-in ELT (201 inside 201), he or she simply locates the game device; turn the power on then activate the ELT via keystroke sequences and/or voice commands via built-in microphone. (110)
2. In case of emergency, for the ELT game device users with a stand-alone separated ELT cartridge (201), he or she simply locates the game device, plug the ELT cartridge (201) into the game device; Turn the power on, activate the ELT via keystroke sequences and/or voice commands via microphone (110).
3. In case of emergency, and simply plug the ELT (201) cartridge into the game device (101). The ELT device can be remotely activated via the cellular or radio network by parents, operator or police.
4. In case of emergency, the ELT cartridge (201) can be a stand alone unit, got built-in battery, always on and in low-power mode, can monitoring and responding to cellular phone remote control command and activate the GPS to report the location of the ELT.
5. Please note: the microphone FIG. 1 of 4 (110) can be used as a monitoring device to listen to the situation in the development.

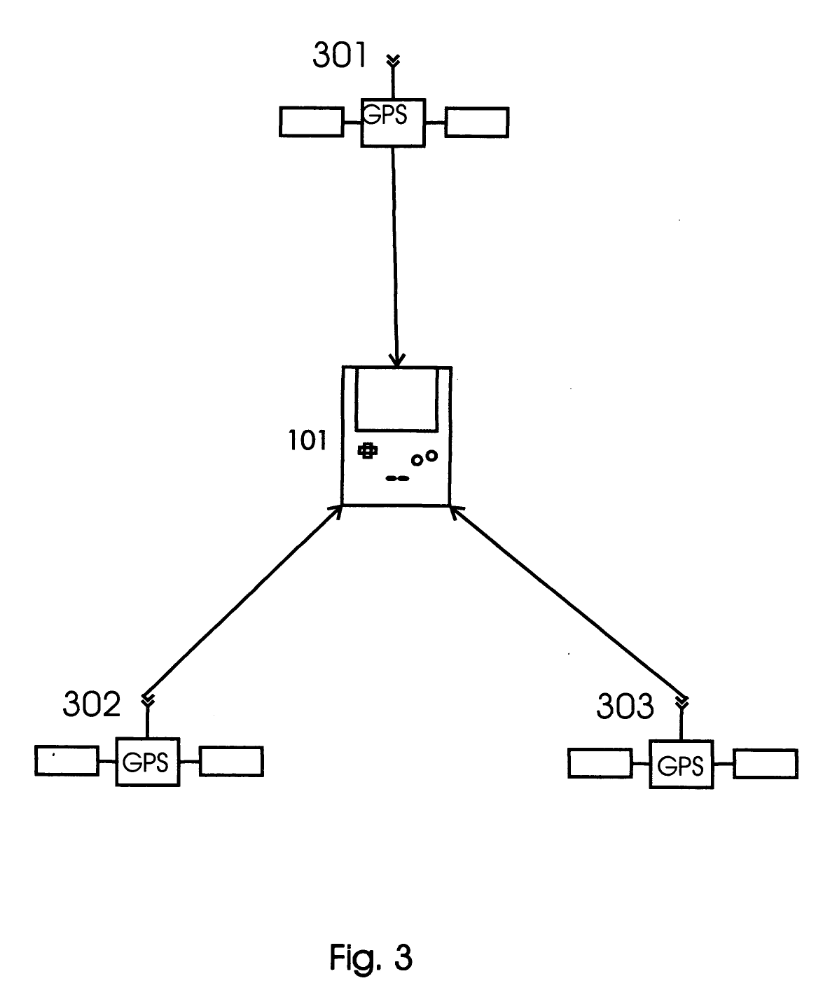

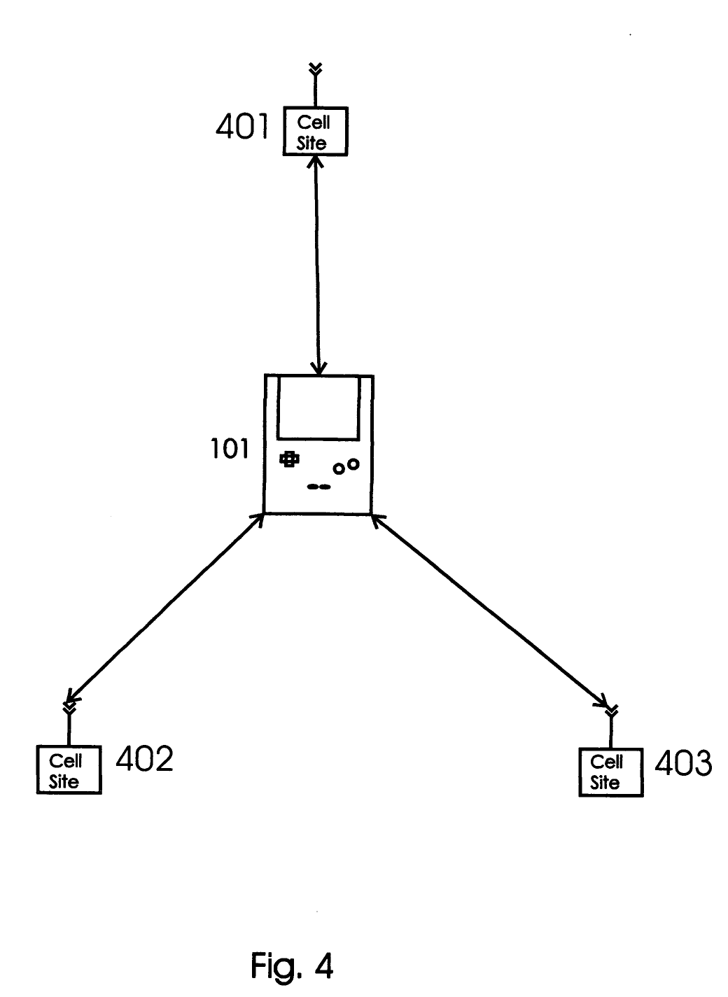

C. Locating the person and the device
1. Via satellites, FIG. 3 of 4, the game device (101) with ELT (201) built-in or plug-in can receive GPS satellites 301, 302 and/or 303 and determine the longitude or latitude of the troubled person by triangulating these 3 satellites. Typical GPS receiver (105) requires line-of-sight visibilities to the satellites to receive the satellites signal. The GPS satellite receiver (105) is a receiving only device.
2. Via cellular phone network, FIG. 4 of 4, the game device (101) with ELT (201) built-in or plug-in can receive cellular phone signals via multiple cellular phone base-station sites (401, 402, 403) to determine the distance from the cellular phone sites to locate the ELT (201) device. Typically land-based transceivers require at least 2 cellular sites to “pin-point” the ELT device.
   Thus the scope of the invention should be determined by the appended claims and their legal equivalents, rather than by the examples given.

1. Disguised Emergency Locator Transmitter (ELT) devices installed inside personal belongings to assist their parents, relatives and/or law-enforcement agencies to locate persons in case of emergency, comprising of:
a. Two-way radio with transmitter/receiver means,
b. Position/location determine means,
c. Control and activate means to turn said ELT on in case of emergency, and
d. Power supply means to supply the operating electrical voltages and currents for said Emergency Locator Transmitter (ELT) circuitries;
Whereby the said emergency locator transmitter (elt) devices are sending location information signals to said parents, said relatives, system operators and/or said law-enforcement agencies in case of emergency.

2. The said disguised Emergency Locator Transmitter (ELT) devices of claim 1, said personal belongings are things such as:
a. Things for persons to wear, such as shoes, clothes and/or jewelry,
b. Toys,
c. Lunch boxes, backpacks, purses, and/or
d. Anything belongs to, carries by, comes, goes and travels with said persons.

3. The said disguised Emergency Locator Transmitter (ELT) devices of claim 1, installed inside of the popular handheld video game devices.

4. The said disguised Emergency Locator Transmitter (ELT) devices of claim 1, disguised as plain plug-in handheld video game cartridges that plugs directly into the said handheld video game devices.

5. The said disguised Emergency Locator Transmitter (ELT) devices of claim 1, wherein said position/location determine means comprising of hardware, software and/or:
a. Satellite based position tracking receiver such as Global Position System (GPS) (USA) or GLONASS (Russian) satellite receivers,
b. Non-satellite, fixed ground cellular phone base-station position tracking receivers,
c. Non-satellite mobile position tracking receiver such as LoJack™ receivers.

6. The said disguised Emergency Locator Transmitter (ELT) devices of claim 1, wherein said two-way radio with transmitter/receiver means comprising of:
a. Satellite radio telephone devices and their service networks,
b. Digital or analog cellular telephone devices and their service networks,
c. Two-way paging devices and its service networks, or
d. Other radio wave transmitter and receiver devices and their service networks.

7. The said disguised Emergency Locator Transmitter (ELT) of claim 1, wherein said control and activate means comprising of:
a. Remote control activating; the said Emergency Locator Transmitter (ELT) devices are activated by said parents, said relatives, said system operators or said law-enforcement agencies,
b. User control key stroke command sequences activating the said Emergency Locator Transmitter (ELT) devices by the persons in case of trouble, and/or
c. Voice command recognition circuit activating the said Emergency Locator Transmitter (ELT) devices by recognizing the persons' voice preset keyword command in case of need help.

8. The said disguised Emergency Locator Transmitter (ELT) devices of claim 1, wherein said power supply means are electrical voltages and currents required to operate said Emergency Locator Transmitter (ELT) comprising of:
a. Self-contained battery power source,
b. Power supplied from the main said toy unit. And/or
c. Power supplied from the said handheld video game device.

9. A method of locating a person from lost, missing, kidnapped, abducted and/or all emergency situations comprising steps of:
a. Providing disguised Emergency Locator Transmitter (ELT) devices installed inside a person's belongings,
b. Providing position/location determine devices and two-way radio with transmitter/receiver devices as the said disguised Emergency Locator Transmitter (ELT) devices,
c. Providing power supply means to the said disguised Emergency Locator Transmitter (ELT) Devices, and
d. Providing control and activate means for turning on the said disguised Emergency Locator Transmitter (ELT) in case of emergency;
Whereby said disguised Emergency Locator Transmitter (ELT) devices are sending location information signals to their parents, relatives, system operators or law-enforcement agencies in case of emergency.

10. The said method of claim 9, said belongings are personal things such as:
a. Things for persons to wear such as shoes, clothes and/or jewelry,
b. Toys,
c. Lunch boxes, backpacks, purses, bikes, and/or
d. Anything belongs to, carries by, comes, goes and travels with persons.

11. The method of claim 9, wherein said position/location determine receivers comprising of:
a. Satellite based position tracking device such as Global Position System (GPS) (USA) or GLONASS (Russian) satellite receivers,
b. Non-satellite, fixed ground cellular phone base-station position tracking devices, or
c. Non-satellite, mobile position tracking receivers such as LoJack™ receivers.

12. The said method of claim 9, wherein said two-way transmitter/receiver means comprising of:
a. Satellite telephone devices and their service networks,
b. Digital or analog cellular telephone devices and their service networks,
c. Two-way paging devices and their service networks, or
d. Other radio wave transmitter and receiver devices and their service networks.

13. The said method of claim 9, wherein said control and activate means comprising of:
a. Remote control activating; the Emergency Locator Transmitter (ELT) devices are activated by parents, system operators or law-enforcement agencies remotely,
b. User control key/switch stroke command sequence activating the said Emergency Locator Transmitter (ELT) devices by kids or persons in case of trouble, and/or
c. Voice command recognition activating the said Emergency Locator Transmitter (ELT) by recognizing the kids' or persons' preset voice commands.

14. The said method of claim 9, wherein said power supply means are electrical voltages and currents required to operate the said Emergency Locator Transmitter (ELT) devices comprising of:
a. Self-contained battery power sources,
b. Power supplied from the main said toys unit, and/or
c. Power supplied from the said handheld video game devices.
